(19) United States
(12) Patent Application Publication
(10) Pub. No.: US 2020/0076919 A1
(43) Pub. Date: Mar. 5, 2020

(54) METHOD, DEVICE, AND COMPUTER READABLE STORAGE MEDIUM FOR MANAGING HARDWARE MODULES OF PAYMENT TERMINAL

(71) Applicant: SHENZHEN PAX SMART NEW TECHNOLOGY CO., LTD., Shenzhen (CN)

(72) Inventors: Jiale REN, Shenzhen (CN); Aiping ZHOU, Shenzhen (CN); Riying WANG, Shenzhen (CN); Gengxin WU, Shenzhen (CN); Xiuliang CHEN, Shenzhen (CN); Daoyang LIU, Shenzhen (CN)

(73) Assignee: SHENZHEN PAX SMART NEW TECHNOLOGY CO., LTD., Shenzhen (CN)

(21) Appl. No.: 16/462,694

(22) PCT Filed: Aug. 4, 2017
(86) PCT No.: PCT/CN2017/096090

§ 371 Date: May 21, 2019

(30) Foreign Application Priority Data
May 25, 2017 (CN) 201710377927.0

(51) Int. Cl. H04L 29/08; G07G 1/00; G07G 1/12; G06F 9/54

(52) U.S. Cl. CPC H04L 67/32; G07G 1/0009; H04L 67/42; G06F 9/545; G06F 2209/543; G07G 1/12

(57) ABSTRACT

A method and an apparatus for managing a hardware module of a payment terminal and a computer readable storage medium, aiming to uniformly manage the hardware modules of the payment terminal and to reduce the adverse influence on the POS application development. The method includes receiving a request to use a hardware module initiated by an application by calling an unified interface, where the request carries an identifier of the hardware module; calling a hardware interface corresponding to the hardware module according to the identifier of the hardware module; and returning an execution result of calling the hardware interface to the application that initiates the request.

### TECHNICAL FIELD

The present application relates to the field of financial equipment, and in particular, to a method and an apparatus for managing a hardware module of a payment terminal and a computer readable storage medium.

### BACKGROUND

Point Of Sale (POS) is a convenient payment device in the financial field and plays an increasingly important role in modern financial activities. At present, most POS operating systems are developed based on the Linux kernel, and the management of the POS hardware modules is based on the process management, that is, after the first process opens a hardware module, regardless of whether it is in use or not, the second process cannot access this hardware module until the first process releases the hardware module.

There are usually multiple applications in the POS. If an application (composed of one or more processes) does not release the built-in hardware module of the POS in time after using it, all other applications cannot access the hardware module. Since in the development process of the applications in the POS, different applications may be developed by different developers in different time periods, one result is that when developer A is developing application A1, application A1 takes up built-in hardware module H the POS, if application A2 also needs to use hardware module H when developer B is developing application A2, since developer A does not release the occupation of the hardware module H by application A1 in time after application A1 uses hardware module H, the application A2 developed by developer B cannot use hardware module H, which may delay the development progress of the application; for the external hardware module of the POS, such as a scanner, an electronic signature board, etc., the POS application developers have the same problems.

The above problems need to be resolved.

### SUMMARY

The present application provides a method and an apparatus for managing a hardware module of a payment terminal and a computer readable storage medium, aiming to uniformly manage the hardware modules of the payment terminal and to reduce the adverse influence on the POS application development.

As a first aspect of the present application, it is provided a method for managing a hardware module of a payment terminal, including:

receiving a request to use a hardware module H initiated by an application by calling an unified interface, where the request carries an identifier of the hardware module H;

calling a hardware interface corresponding to the hardware module H according to the identifier of the hardware module H; and

returning an execution result of calling the hardware interface to the application that initiates the request.

As a second aspect of the present application, it is provided an apparatus for managing a hardware module of a payment terminal, including:

a receiving module configured to receive a request to use a hardware module H initiated by an application by calling an unified interface, where the request carries an identifier of the hardware module H;

a calling module configured to call a hardware interface corresponding to the hardware module H according to the identifier of the hardware module H; and

a result returning module configured to return an execution result of calling the hardware interface to the application that initiates the request.

As a third aspect of the present application, it is provided a terminal device including a memory, a processor, and a computer program stored in the memory and executable by the processor, wherein the processor implements following steps when executing the computer program:

receiving a request to use a hardware module H initiated by an application by calling an unified interface, where the request carries an identifier of the hardware module H;

calling a hardware interface corresponding to the hardware module H according to the identifier of the hardware module H; and

returning an execution result of calling the hardware interface to the application that initiates the request.

As a fourth aspect of the present application, it is provided a computer readable storage medium storing a computer program, wherein the computer program implements following steps when executed by a processor:

receiving a request to use a hardware module H initiated by an application by calling an unified interface, where the request carries an identifier of the hardware module H;

calling a hardware interface corresponding to the hardware module H according to the identifier of the hardware module H; and

returning an execution result of calling the hardware interface to the application that initiates the request.

From a technical solution provided by the present application, it can be learnt that, on one hand, the requests to use the hardware module H are initiated by the applications by calling the unified interface, compared with the prior art, the technical solutions provided by the present application does not need the developers of the applications to directly call the hardware interfaces corresponding to respective hardware modules so that the developers can focus on the business processes rather than the operation of the hardware devices, thereby greatly improving the efficiency of application development; on the other hand, the hardware interfaces corresponding to respective hardware modules are not directly called by the developers of the applications, actually the requests initiated by the applications by calling the unified interface are received first, and then the hardware interface corresponding to the hardware module H are called, thus it is possible to uniformly manage the calling to the hardware interfaces by the applications and the situation that the application occupies the hardware module without releasing it, causing other applications incapable of using this hardware module, thereby affecting the progress of development, is unlikely to occur, therefore the efficiency of application development can be improved.

### BRIEF DESCRIPTION OF THE DRAWINGS

In order to more clearly illustrate the technical solutions in the embodiments of the present application, the drawings used in the embodiments or the description of the prior art will be briefly described below. It is obvious that the drawings in the following description are only for some embodiments of the present application and to those skilled in the art other drawings may be obtained from these drawings without paying creative effort.

FIG. 1 is a schematic flowchart of an implementation process of a method for managing a hardware module of a payment terminal according to an embodiment of the present application;

FIG. 2 is a schematic diagram of a system architecture according to an embodiment of the present application;

FIG. 3 is a schematic diagram of a C/S architecture of an intermediate layer in a system architecture according to an embodiment of the present application;

FIG. 4 is a schematic diagram of a full-duplex communication mode in which a client and a server of an intermediate layer are communicated to each other in a shared memory manner according to an embodiment of the present application;

FIG. 5 is a schematic diagram of structural of an apparatus for managing a hardware module of a payment terminal according to an embodiment of the present application;

FIG. 6 is a schematic diagram of structural of an apparatus for managing a hardware module of a payment terminal according to another embodiment of the present application; and

FIG. 7 is a schematic diagram of structural of a terminal device according to an embodiment of the present application.

### DETAILED DESCRIPTION OF THE EMBODIMENTS

In the following description, for the purposes of illustration instead of limitation, specific details such as specific system structures, techniques, etc. are presented for a thorough understanding of embodiments of the present application. However it will be apparent to those skilled in the art that other embodiments without these specific details can also realize the present application. In other instances, detailed descriptions of well-known systems, apparatus, circuits, and methods are omitted so as not to obscure the description of the present application.

In order to explain the technical solutions of the present application, the following description will be made by way of specific embodiments.

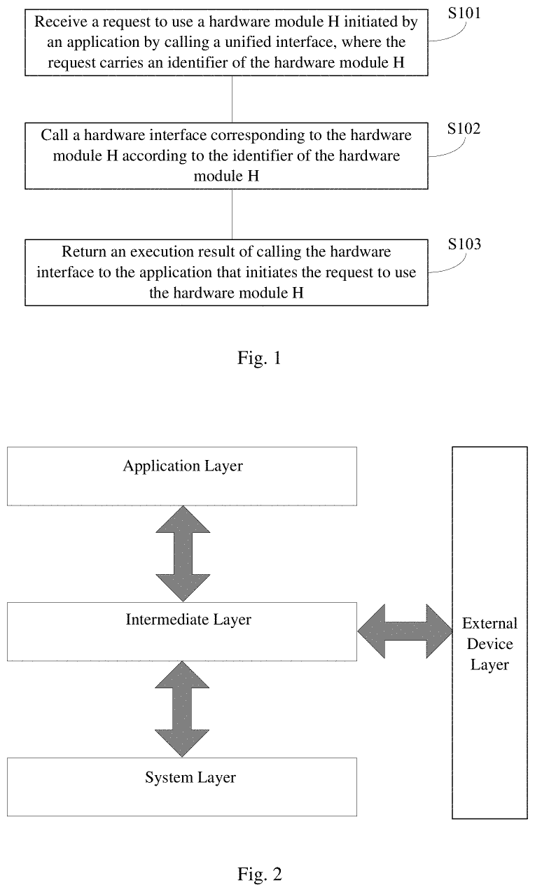

FIG. 1 is a schematic flowchart of an implementation of a method for managing a hardware module of a payment terminal according to an embodiment of the present application. The execution body may be in an intermediate layer of the system, and the intermediate layer is below the application layer and above the system layer, as shown in the attached drawing, as shown in FIG. 2, the intermediate layer may interact with the application layer, the system layer, and the external device layer, where the external device layer provides a hardware interface for a POS external hardware module, such as a scanner and an electronic signature board and the like. The method illustrated in FIG. 1 mainly includes the following steps S101 to S103, which are described in detail as follows.

S101. receiving a request to use a hardware module H initiated by an application by calling an unified interface, where the request carries an identifier of the hardware module H.

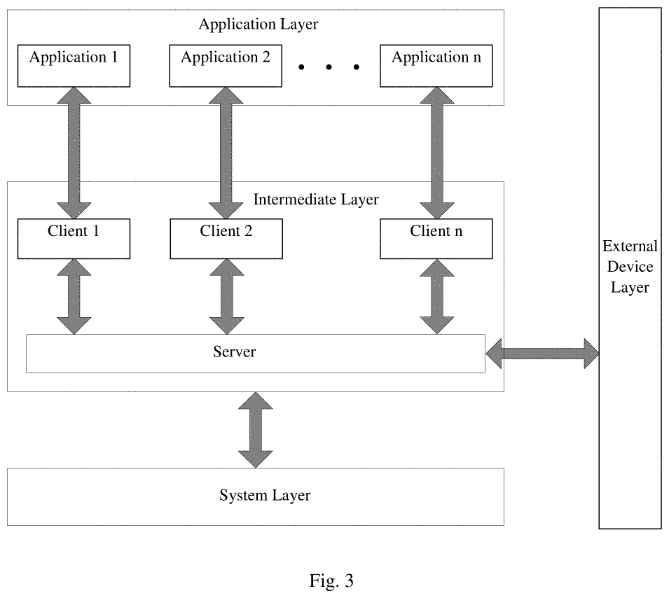

The intermediate layer shown in FIG. 2 is actually a client/server (C/S) architecture, as shown in FIG. 3, where there may be multiple clients but only one server, a client interacts with an application at the application layer, a client corresponds to a client process, and the server corresponds to a server process.

Different from prior art, in which the application directly calls the hardware interface of the hardware module when initiating a request to use a POS hardware module, in an embodiment of the present application, said receiving a request to use a hardware module H initiated by an application by calling an unified interface is receiving, by a client, a request to use a hardware module H initiated by an application by calling an unified interface. The so-called unified interface means that no matter which application initiates a request to use a POS hardware module by calling an unified interface, the interface called is an interface of the same form, the difference is only the communication handle is different (of course, if different applications call different hardware modules, there are differences in the input parameters, but the interface is still an interface of the same form). As shown in FIG. 3, if the application 1 of the application layer needs to use the hardware module H, the application 1 initiates the request to use the hardware module H by calling the unified interface, and the client 1 of the intermediate layer receives the request to use the hardware module 1 initiated by the application 1; if the application layer 2 of the application layer needs to use the hardware module H, the application 2 initiates the request to use the hardware module H still by calling the unified interface, and the client 2 of the intermediate layer receives the request to use the hardware module H initiated by the application 2, and so on.

S102. calling a hardware interface corresponding to the hardware module H according to the identifier of the hardware module H.

In the embodiment of the present application, the hardware module H may either be a POS built-in hardware module or be a POS external hardware module. Therefore, the hardware interface corresponding to the hardware module H may be a hardware interface of a POS built-in hardware module provided by the system layer or be a hardware interface of the POS external hardware module provided by the external device layer. It should be noted that, no matter whether it is a POS built-in hardware module or a POS external hardware module, in an embodiment of the present application, each hardware module is separately processed by an independent hardware module process, and the independent hardware module process has a server and multiple clients, each client has two independent communication channels with the server, and does not need to interact with processes corresponding to other hardware modules.

Since there are multiple applications, there is a possibility that multiple applications initiate usage requests for the same hardware module of the POS, that is, concurrent requests to the server. In order to convert the concurrent requests into a serial request, in an implementation of the present application, after receiving a request to use a hardware module H initiated by an application by calling an unified interface and before calling a hardware interface corresponding to the hardware module H according to the identifier of the hardware module H, the method further includes: storing, by the client, the requests to use the hardware module H initiated by the applications in the shared memory of the server and the client in a queue manner according to the order in which the requests are initiated.

As an embodiment of the present application, calling a hardware interface corresponding to the hardware module H according to the identifier of the hardware module H may be: reading, by the server, the request from the shared memory and calling the hardware interface corresponding to the hardware module H according to the identifier of the hardware module H. Since the requests to use the hardware module H initiated by the applications are stored in the shared memory in a queue manner, and the queue is a first in first out (FIFO) data structure, it is guaranteed that the application which initiates the request to use hardware module by calling the unified interface first can obtain the service preferentially, that is, can use the hardware module H preferentially.

S103. returning an execution result of calling the hardware interface to the application that initiates the request to use the hardware module H.

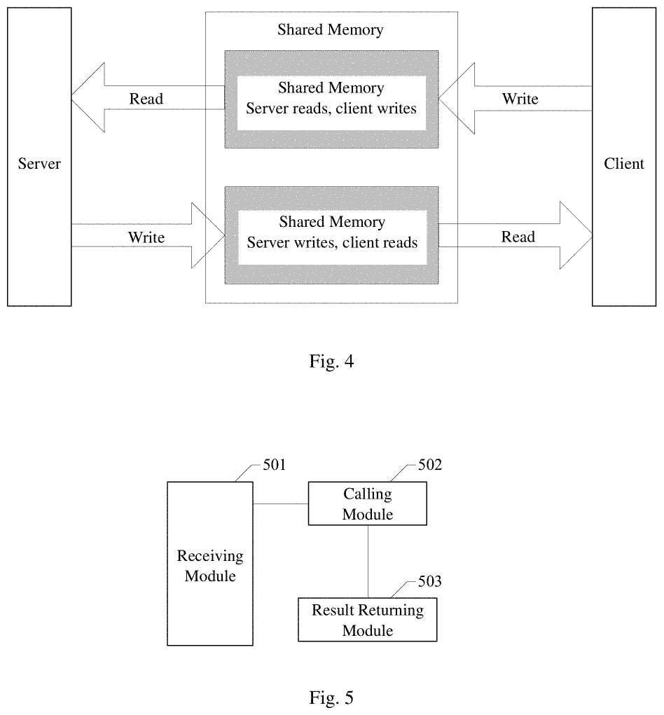

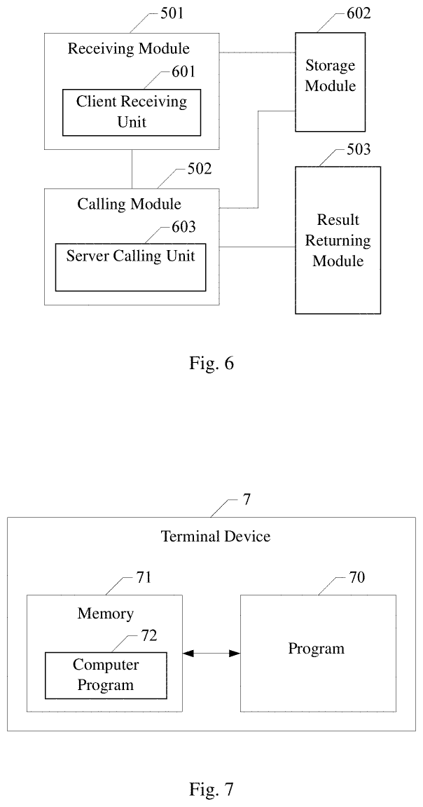

In the embodiment of the present application, the server and the client of the intermediate layer perform communication in the full duplex mode through the shared memory and semaphore mechanism. As shown in FIG. 4, each client has two data channels with the server, one for reading data from the shared memory and one for writing data to the shared memory. The data stored in the shared memory includes the requests to use the hardware interface initiated by the applications by calling the unified interface and the execution results after calling the hardware interface. The process in which the server reads the request from the shared memory or the client reads the execution result from the shared memory is a process of reading a piece of data from the shared memory, and the process in which the client writes the requests to use the hardware module initiated by the applications by calling the unified interface to the shared memory or the server writes the execution results to the shared memory is a process of writing a piece of data to the shared memory. Each piece of data includes three parts: communication handle, communication data length and communication data, the format of the data is as follows:

| | | |
|---|---|---|
| communication handle | communication data length | communication data |
| (4 bytes) | (2 bytes) | (N bytes) |

Among them, the communication handle indicates the owner of the data, that is, who reads or writes the piece of data. In general, the ID of the thread can be used as the communication handle, and the format of the communication data is defined as follows.

Communication Data

| | Type | Opera- | | |
|---|---|---|---|---|
| | of hard- | tional- | | |
| | ware | instruc- | | |
| | module | tion | Length | Data |
| Client | 1 byte | 1 byte | 2 bytes | Data format sent by client to |
| sending | | | (total | server: data length of input |
| format | | | length | parameter 1 (2 bytes) + data |
| | | | of data) | of input parameter 1 + data |
| | | | | length of input parameter 2 (2 |
| | | | | bytes) + data of input param- |
| | | | | eter 2+ . . . +data length |
| | | | | of input parameter n (2 bytes) + |
| | | | | data of input parameter n |
| Client | 1 byte | 1 byte | 2 bytes | Data format returned by server |
| receiving | | | (total | to client: return code (4 bytes) + |
| format | | | length | data length of output parameter |
| | | | of data) | 1 (2 bytes) + data of output |
| | | | | 1 + data length of output 2 |
| | | | | (2 bytes) + data of output |
| | | | | 2+ . . . +data length of output |
| | | | | n (2 bytes) + data of output n |

The type of the hardware module of the POS may be used as the identifier of the hardware module H carried in the request to use the hardware module H initiated by the application. An example of the type of hardware module is as follows:
System module: 0x01
PED module: 0x02
Magnetic card module: 0x03
Contact IC card module: 0x04
Contactless IC card module: 0x05
Printing module: 0x06
Communication module: 0x07
Scanning module: 0x08

A plurality of applications may initiate requests to use the hardware module for the same hardware module of the POS, and the requests are stored in the shared memory by the corresponding clients in the order in which the requests was initiated. The server reads the requests from the shared memory and calls, according to the identifiers of the hardware modules carried in the requests, the hardware interfaces of the corresponding hardware modules one by one to process, thereby changing the parallel requests into a serial request through the shared memory block and the semaphore mechanism. For hardware modules, since their interfaces are called by a single one server process in a unified and orderly manner, there is no problem with multiple applications calling their interfaces directly in parallel, and also no problem that an application does not release the hardware module after using it. Because all hardware interfaces are called by a unified server process, management of the hardware modules, such as turning on hardwares, turning off the device and so on, may be performed uniformly by the server process. For the applications, only operations to a uniform interface is needed, which simplifies operations. For example, for the hardware module, the POS magnetic card, the operations related to its hardware interface include turn-on, reset, detecting whether there is a card, reading the card, turn-off, etc., and only calling, by the server process, the hardware interfaces corresponding to reset, detecting whether there is a card and reading a card is needed, and the application does not need to consider the hardware interface corresponding to turn-on and turn-off, thus simplifying the operation to the magnetic card module.

It should be noted that, for the hardware modules of the same function, they may be hardware modules built in the POS or hardware modules external to the POS, and the external hardware modules may have different product models and different communication protocols and so on. In an embodiment of the present application, the server of the intermediate layer integrates the processing of calling the hardware modules in advance, and the hardware modules can be accurately accessed only according to the identifiers of the hardware modules in the requests forwarded by the clients. In other words, the various differences generated by these different hardware modules are shielded by the server. For the developers of the applications, no matter whether they are built-in hardware modules or external hardware modules, only the unified interface, that is, the same interface, needs to be called to perform the same logic processing. The only requirement is to specify the identifier of the hardware module to be used in the input parameter of the unified interface.

From the example method for managing the hardware module of the payment terminal in FIG. 1, it can be learnt that, on one hand, the requests to use the hardware module H are initiated by the applications by calling the unified interface, compared with the prior art, the technical solutions provided by the present application does not need the developers of the applications to directly call the hardware interfaces corresponding to respective hardware modules so that the developers can focus on the business processes rather than the operation of the hardware devices, thereby greatly improving the efficiency of application development; on the other hand, the hardware interfaces corresponding to respective hardware modules are not directly called by the developers of the applications, actually the requests initiated by the applications by calling the unified interface are received first, and then the hardware interface corresponding to the hardware module H are called, thus it is possible to uniformly manage the calling to the hardware interfaces by the applications and the situation that the application occupies the hardware module without releasing it, causing other applications incapable of using this hardware module, thereby affecting the progress of development, is unlikely to occur, therefore the efficiency of application development can be improved.

FIG. 5 is a schematic diagram of an apparatus for managing a hardware module of a payment terminal according to an embodiment of the present invention, which may be a terminal device or a functional module therein. The apparatus for managing a hardware module of a payment terminal illustrated in FIG. 5 mainly includes a receiving module 501, a calling module 502, and a result returning module 503, which are described in detail as follows:

the receiving module 501 is configured to receive a request to use a hardware module H initiated by an application by calling an unified interface, where the request carries an identifier of the hardware module H;

the calling module 502 is configured to call a hardware interface corresponding to the hardware module H according to the identifier of the hardware module H;

the result is configured to return an execution result of calling the hardware interface to the application that initiates the request.

It should be noted that the apparatus provided by the embodiment of the present application has the same conception as the method embodiment of the present application, and its technical effect is the same as that of the method embodiment of the present application. For details, reference to the description in the method embodiment of the present application may be made, which will not be repeatedly described here.

The receiving module 501 illustrated in FIG. 5 includes a client receiving unit 601, and the calling module 502 includes a server calling unit 603. The apparatus for managing a hardware module of a payment terminal further includes a storage module 602, where:

the client receiving unit 601 is configured to receive, by a client, the request to use the hardware module H initiated by the application by calling the unified interface, the client being a client in an intermediate layer between an application layer and a system layer;

the storage module 602 is configured to store, by the client, the request in a shared memory of a server and the client in a queue manner according to an order in which the request is initiated, after said receiving, by the receiving module 501, a request to use a hardware module H initiated by an application by calling an unified interface and before said calling, by the calling module 502, a hardware interface corresponding to the hardware module H according to the identifier of the hardware module H, where the server is a server in the intermediate layer;

the server calling unit 603 is configured to read, by the server, the request from the shared memory and call the hardware interface corresponding to the hardware module H according to the identifier of the hardware module H.

FIG. 7 is a schematic diagram of structural of a terminal device according to an embodiment of the present application. As shown in FIG. 7, the terminal device 7 of this embodiment includes a processor 70, a memory 71, and a computer program 72, such as a program for a method for managing a hardware module of a payment terminal, stored in the memory 71 and executable by the processor 70. The processor 70, when executing the computer program 72, implements the steps in the method embodiments for managing a hardware module of a payment terminal described above, such as steps S101 to S103 shown in FIG. 1. Alternatively, the processor 70, when executing the computer program 72, implements the functions of the various modules/units in the various apparatus embodiments described above, such as the functions of the receiving module 501, the calling module 502, and the result returning module 503 shown in FIG. 5.

Exemplarily, the computer program 72 for the method for managing a hardware module of a payment terminal mainly includes: receiving a request to use a hardware module H initiated by an application by calling an unified interface, where the request carries an identifier of the hardware module H; calling a hardware interface corresponding to the hardware module H according to the identifier of the hardware module H; and returning an execution result of calling the hardware interface to the application that initiates the request. The computer program 72 can be divided into one or more modules/units stored in the memory 71 and executed by the processor 70 to complete the present application. The one or more modules/units may be a series of computer program instructions that are capable of performing a particular function, the instructions is used to describe the execution of the computer program 72 in terminal device 7. For example, the computer program 72 can be divided into a receiving module, a calling module, and a result returning module (modules in a virtual device). The specific functions of each module are as follows: the receiving module is configured to receive a request to use a hardware module H initiated by an application by calling an unified interface, where the request carries an identifier of the hardware module H; the calling module is configured to call a hardware interface corresponding to the hardware module H according to the identifier of the hardware module H; and the result returning module is configured to return an execution result of calling the hardware interface to the application that initiates the request.

The terminal device 7 may be a computing device such as a desktop computer, a notebook, a palmtop computer, and a cloud server. The terminal device 7 may include, but is not limited to, the processor 70 and the memory 71. It can be understood for one of ordinary skill in the art that, FIG. 7 is merely an example of the terminal device 7, and is not constituted as limitation to the terminal device 7, more or less components shown in FIG. 7 can be included, or some components or different components can be combined; for example, the terminal device may also include an input and output device, a network access device, a bus, etc.

The processor 70 may be CPU (Central Processing Unit), and may alternatively be other general purpose processor, DSP (Digital Signal Processor), ASIC (Application Specific Integrated Circuit), FGPA (Field-Programmable Gate Array), or some other programmable logic devices, discrete gate or transistor logic device, discrete hardware component, etc. The general purpose processor may be a microprocessor, or alternatively, the processor may be any conventional processor and so on.

The memory 71 may be an internal storage unit of the terminal device 7, such as a hard disk or an internal memory of the terminal device 7. The memory 71 may alternatively be an external storage device of the terminal device 7, such as a plug-in hard disk, a SMC (Smart Media Card), a SD (Secure Digital) card, a FC (Flash Card) equipped on the terminal device 7. Further, the memory 71 may include both the internal storage unit and the external storage device of the terminal device 7. The memory 71 is configured to store the computer programs, and other procedures and data needed by the terminal device 7. The memory 71 may also be configured to store data that has been output or being ready to be output temporarily.

It can be clearly understood by the one of ordinary skill in the art that, for describing conveniently and concisely, dividing of the aforesaid various functional units, functional modules is described exemplarily merely, in an actual application, the aforesaid functions can be assigned to different functional units and functional modules to be accomplished, that is, an inner structure of a data synchronizing device is divided into functional units or modules so as to accomplish the whole or a part of functionalities described above. The various functional units, modules in the embodiments can be integrated into a processing unit, or each of the units exists independently and physically, or two or more than two of the units are integrated into a single unit. The aforesaid integrated unit can by either actualized in the form of hardware or in the form of software functional units. In addition, specific names of the various functional units and modules are only used for distinguishing from each other conveniently, but not intended to limit the protection scope of the present application. Regarding a specific working process of the units and modules in the aforesaid device, reference can be made to a corresponding process in the aforesaid method embodiments, it is not repeatedly described herein.

In the aforesaid embodiments, the description of each of the embodiments is emphasized respectively, regarding a part of one embodiment which isn't described or disclosed in detail, please refer to relevant descriptions in some other embodiments.

The ordinarily skilled one in the art may aware that, the elements and algorithm steps of each of the examples described in connection with the embodiments disclosed herein can be implemented in electronic hardware, or in combination with computer software and electronic hardware. Whether these functions are implemented by hardware or software depends on the specific application and design constraints of the technical solution. The skilled people could use different methods to implement the described functions for each particular application, however, such implementations should not be considered as going beyond the scope of the present application.

It should be understood that, in the embodiments of the present application, the disclosed device/terminal device and method could be implemented in other ways. For example, the device described above are merely illustrative; for example, the division of the units is only a logical function division, and other division could be used in the actual implementation, for example, multiple units or components could be combined or integrated into another system, or some features can be ignored, or not performed. In another aspect, the coupling or direct coupling or communication connection shown or discussed could be through some interfaces, and indirect coupling or communication connection between devices or units may be electrical, mechanical, or in other manners.

The units described as separate components could or could not be physically separate, the components shown as units could or could not be physical units, which can be located in one place, or can be distributed to multiple network elements. Parts or all of the elements could be selected according to the actual needs to achieve the object of the present embodiment.

In addition, the various functional units in each of the embodiments of the present application can be integrated into a single processing unit, or exist individually and physically, or two or more than two units are integrated into a single unit. The aforesaid integrated unit can either be achieved by hardware, or be achieved in the form of software functional units.

If the integrated module/unit is achieved in the form of software functional units, and is sold or used as an independent product, it can be stored in a computer readable storage medium.

Based on such understanding, all or part of the processes in the foregoing method embodiments may also be implemented by using a computer program to instruct related hardware. The computer program for the method for managing a hardware module of a payment terminal may be stored in a computer readable storage medium. The computer program, when executed by the processor, may implement the steps of the method embodiments as described above, that is, receiving a request to use a hardware module H initiated by an application by calling an unified interface, where the request carries an identifier of the hardware module H; calling a hardware interface corresponding to the hardware module H according to the identifier of the hardware module H; and returning an execution result of calling the hardware interface to the application that initiates the request. The computer program includes computer program codes, which can be in the form of source code, object code, executable documents or some intermediate form, etc. The computer readable medium can include: any entity or device that can carry the computer program codes, recording medium, USB flash disk, mobile hard disk, hard disk, optical disk, computer storage device, ROM (Read-Only Memory), RAM (Random Access Memory), electrical carrier signal, telecommunication signal and software distribution medium, etc. It needs to be explained that, the contents contained in the computer readable medium can be added or reduced appropriately according to the requirement of legislation and patent practice in a judicial district, for example, in some judicial districts, according to legislation and patent practice, the computer readable medium doesn't include electrical carrier signal and telecommunication signal. As stated above, the aforesaid embodiments are only intended to explain but not to limit the technical solutions of the present application. Although the present application has been explained in detail with reference to the above-described embodiments, it should be understood for the ordinary skilled one in the art that, the technical solutions described in each of the above-described embodiments can still be amended, or some technical features in the technical solutions can be replaced equivalently; these amendments or equivalent replacements, which won't make the essence of corresponding technical solution to be broken away from the spirit and the scope of the technical solution in various embodiments of the present application, should all be included in the protection scope of the present application.

1-10. (canceled)

11. A method for managing a hardware module of a payment terminal, comprising:
receiving a request to use a hardware module initiated by an application by calling a unified interface, wherein the request carries an identifier of the hardware module;
calling a hardware interface corresponding to the hardware module according to the identifier of the hardware module; and
returning an execution result of calling the hardware interface to the application that initiates the request.

12. The method for managing a hardware module of a payment terminal according to claim 11, wherein said receiving a request to use a hardware module initiated by an application by calling an unified interface, where the request carries an identifier of the hardware module comprises:
receiving, by a client, the request to use the hardware module initiated by the application by calling the unified interface, the client being a client in an intermediate layer between an application layer and a system layer;
after said receiving a request to use a hardware module initiated by an application by calling an unified interface and before said calling a hardware interface corresponding to the hardware module according to the identifier of the hardware module, the method further comprising:
storing, by the client, the request in a shared memory of a server and the client in a queue manner according to an order in which the request is initiated, where the server is a server in the intermediate layer;
said calling a hardware interface corresponding to the hardware module according to the identifier of the hardware module comprises:
reading, by the server, the request from the shared memory and calling the hardware interface corresponding to the hardware module according to the identifier of the hardware module.

13. The method for managing a hardware module of a payment terminal according to claim 12, wherein the server and the client perform communication in a full duplex mode through a shared memory and semaphore mechanism.

14. The method for managing a hardware module of a payment terminal according to claim 11, wherein the identifier of the hardware module is specified in an input parameter of the unified interface.

15. An apparatus for managing a hardware module of a payment terminal, comprising:
a receiving module configured to receive a request to use a hardware module initiated by an application by calling an unified interface, where the request carries an identifier of the hardware module;
a calling module configured to call a hardware interface corresponding to the hardware module according to the identifier of the hardware module; and
a result returning module configured to return an execution result of calling the hardware interface to the application that initiates the request.

16. The apparatus for managing a hardware module of a payment terminal according to claim 15, wherein the receiving module comprises:
a client receiving unit configured to receive, by a client, the request to use the hardware module initiated by the application by calling the unified interface, the client being a client in an intermediate layer between an application layer and a system layer;
the apparatus further comprising:
a storage module configured to store, by the client, the request in a shared memory of a server and the client in a queue manner according to an order in which the request is initiated, after said receiving, by the receiving module, a request to use a hardware module initiated by an application by calling an unified interface and before said calling, by the calling module, a hardware interface corresponding to the hardware module according to the identifier of the hardware module, where the server is a server in the intermediate layer; and
the calling module comprising:
a server calling unit, configured to read, by the server, the request from the shared memory and call the hardware interface corresponding to the hardware module according to the identifier of the hardware module.

17. The apparatus for managing a hardware module of payment terminal according to claim 16, wherein the server and the client perform communication in a full duplex mode through a shared memory and semaphore mechanism.

18. The apparatus for managing a hardware module of a payment terminal according to claim 15, wherein the identifier of the hardware module H is specified in an input parameter of the unified interface.

19. A terminal device comprising a memory, a processor, and a computer program stored in the memory and executable by the processor, wherein the processor is configured to implement steps of the method according to claim 11 when executing the computer program.
